(19) United States
(12) Patent Application Publication
(10) Pub. No.: US 2008/0168267 A1
(43) Pub. Date: Jul. 10, 2008

(54) SYSTEM AND METHOD FOR DYNAMICALLY CONFIGURING A MOBILE DEVICE

(76) Inventors: Charles S. Bolen, Kings Park, NY (US); Alan J. Epshteyn, Miller Place, NY (US)

Correspondence Address: THORNE & HALAJIAN;APPLIED TECHNOLOGY CENTER, 111 WEST MAIN STREET, BAY SHORE, NY, 11706, US

(21) Appl. No.: 11/621,149

(22) Filed: Jan. 9, 2007

(51) Int. Cl. G06F 1/24

(52) U.S. Cl. 713/100

(57) ABSTRACT

A mobile device includes a sensor configured to detect a usage profile of the mobile device, and a processor configured to reconfigure the mobile device in response to the usage profile. The usage profile may be based on at least one of time, dates, location and user of the mobile device. The processor may be further configured to at least one of switch a power mode, reconfigure a user interface and/or a function of a button of the mobile device in response to at least one of the usage profile and a user profile of a user of the mobile device. The sensor may include at least one of a timer, a location detector, a usage detector and a user detector.

### FIELD OF THE INVENTION

The present invention relates to systems and methods for dynamically configuring mobile devices, such as based on a usage profile, user profile, time and/or location.

### BACKGROUND OF THE INVENTION

Mobile devices have increased exponentially, and include various electronic devices, such as mobile phones, mobile computers, personal digital assistants (PDAs), scanners, remote controller, etc. Mobile devices are typically used in the same manner and throughout the same location(s) day after day. For example, a user at work will typically pick up a PDA or scanner at the beginning of a shift, walk through a warehouse scanning barcodes and replace the PDA at an end of the shift. It is unlikely that the user will bring the PDA outside of the warehouse, or that the PDA will be used on weekends or during off hours outside of the normal shifts or working hours. However, during such non-use times and even during the shift, various components of the PDA may not be used, yet such components are still ON and drawing power from the PDA's battery. Thus, it would be beneficial to limit the draw on the battery by allowing the PDA to dynamically reconfigure its power usage.

Accordingly, there is a need for improved function allocation and power usage of mobile devices to extend battery life, for example.

### SUMMARY OF THE INVENTION

One object of the present systems, devices and methods is to overcome the disadvantages of conventional mobile devices.

This and other objects are achieved by systems, devices and methods comprising a mobile device having a sensor configured to detect a usage profile of the mobile device, and a processor configured to reconfigure the mobile device in response to the usage profile. The usage profile may be based on at least one of time, dates, location and user of the mobile device. The processor may be further configured to at least one of switch a power mode, reconfigure a user interface and/or a function of a button of the mobile device in response to at least one of the usage profile and a user profile of a user of the mobile device. The sensor may include at least one of a timer, a location detector, a usage detector and a user detector.

The present systems, devices and methods provide for improved power management and configuration of the system and/or the user interface (UI) based on a usage profile, user profile, time and/or location, for example. Dynamic power management including adjustment of the power profile and dynamic reconfiguration of the system and UI(s) provide various advantages, such as improving efficiency, extending battery life, extending use on a single battery charge, and/or allowing use of smaller batteries thus allowing further miniaturization of mobile devices, for example.

Further areas of applicability of the present systems, devices and methods, such as methods of operating a mobile device or extending battery life of the mobile device, will become apparent from the detailed description provided hereinafter. It should be understood that the detailed description and specific examples, while indicating exemplary embodiments of the systems and methods, are intended for purposes of illustration only and are not intended to limit the scope of the invention.

### BRIEF DESCRIPTION OF THE DRAWINGS

These and other features, aspects, and advantages of the apparatus, systems and methods of the present invention will become better understood from the following description, appended claims, and accompanying drawings. It should be expressly understood that the drawings are included for illustrative purposes and do not represent the scope of the present system, where:

FIG. 1 shows an illustrative system in accordance with an embodiment of the present system.

### DETAILED DESCRIPTION OF THE INVENTION

The following description of certain exemplary embodiments is merely exemplary in nature and is in no way intended to limit the invention, its application, or uses. In the following detailed description of embodiments of the present systems and methods, reference is made to the accompanying drawings which form a part hereof, and in which are shown, by way of illustration, specific embodiments in which the described systems and methods may be practiced. These embodiments are described in sufficient detail to enable those skilled in the art to practice the presently disclosed system, and it is to be understood that other embodiments may be utilized and that structural and logical changes may be made without departing from the spirit and scope of the present system.

The following detailed description is therefore not to be taken in a limiting sense, and the scope of the present system is defined only by the appended claims. The leading digit(s) of the reference numbers in the figures herein typically correspond to the figure number, with the exception that identical components which appear in multiple figures are identified by the same reference numbers. Moreover, for the purpose of clarity, detailed descriptions of well-known devices and methods are omitted so as not to obscure the description of the present system.

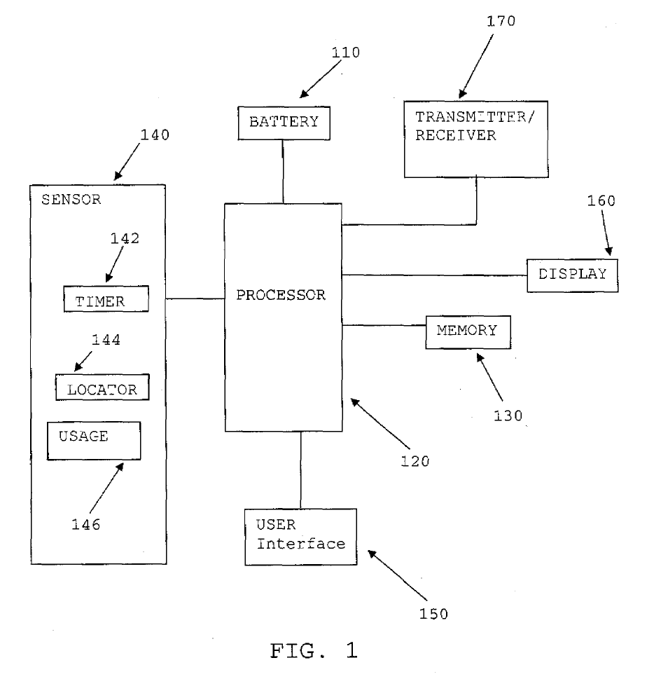

FIG. 1 shows an illustrative system 100 in accordance with an embodiment of the present system which may include a mobile device having a battery 110 that provides power, for example. The various elements of the system 100, e.g., a mobile device, are operationally coupled to each other, such as shown in FIG. 1.

The mobile device or system 100 includes a processor 120 operationally coupled to computer readable medium illustrated as a memory 130, a sensor 140, and a user interface 150. Other elements may also be provided such as a display device 160, and a transmitter/receiver 170.

As is known in the art, the methods and apparatus discussed herein may be distributed as an article of manufacture that itself comprises the memory 130 having computer-readable code embodied thereon. The computer-readable code is operable, in conjunction with the processor 120, to carry out all or some of the acts to perform the methods or create the apparatus discussed herein. The memory 130 may be a recordable medium (e.g., floppy disks, hard drives, DVD, solid state memory, memory cards, etc.) or may be a transmission medium (e.g., a network comprising fiber-optics, the world-wide web, cables, or a wireless channel using time-division multiple access, code-division multiple access, or other radio-frequency channel). Any medium known or developed that can store and/or provide information suitable for use with the system 100 may be used. The computer-readable code is any mechanism for allowing the processor 120 to read and write instructions and data, such as magnetic variations on a magnetic medium, or height/light deflecting variations on the surface of a compact disk, for example.

The memory 130 may be long-term, short-term, or a combination of long and short term memories. The memory 130 configures the processor 120 to implement the methods, acts, and functions disclosed herein. The memory 130 may be distributed or local and the processor 120 may be distributed or singular. For example, the sensor 140, transmitter/receiver 170, etc, may contain a portion of the processor 120 and/or the memory 130 for performing some of the acts described herein and others. The memory 130 may be implemented as electrical, magnetic or optical memory, or any combination of these or other types of storage devices. Moreover, the term “memory” should be construed broadly enough to encompass any information able to be read from or written to an address in an addressable space accessible by the processor 120. With this definition, information on a network is still within the memory 130 since the processor 120 may retrieve/write the information from/to the network. It should also be noted that some or all of operations described herein may be incorporated into an application-specific or general-use integrated circuit including the operation of the processor 120 and the memory 130.

Further, the processor 120 may be a dedicated processor for performing in accordance with the present system or may be a general-purpose processor wherein only one of many functions operates for performing in accordance with the present system. The processor 120 may operate utilizing a program portion, multiple program segments, or may be a hardware device utilizing a dedicated or multi-purpose integrated circuit.

For example, the memory 130 may contain program portions for configuring the processor 120 to dynamically adjust power management and system configuration. For example, the processor 120 may be configured to display on the display 160 a dynamically configurable user interface (UI), which may include soft buttons in the case the display 160 is touch sensitive, for example, for receiving user inputs. Further, the processor 120 may be configured to (i.e., the memory 130 may contain program portions for configuring the processor 120 to) reconfigure the fixed UI 150 and/or to reconfigure button functions or responses to activating buttons, keys, or any other actuation inputs of the fixed UI 150 to facilitate operation of the mobile device 100.

The processor 110 may be configured to autonomously or automatically determine and generate a use profile for control (e.g., power management) and/or for reconfiguration of the mobile device 100 based on various factors, such as detected use of particular functions of the mobile device 100 during particular times of the day, dates, days of the week, location of the mobile device 100, or any other factors which may be predetermined and/or programmable by the user, for example.

The sensor 140 may include one or more sensor elements, such as a timer 142 for detecting and counting time functions, such as time of day and dates. Another sensor element may be a location detector 144 configured to detect location of the mobile device 100 via various manual or automatic means. For example, a GPS (Global Positioning System) detector may be included to provide location information and/or other systems of the like that facilitate an autonomous determination of the location of the mobile device 100.

The location detector 144 may also be based on RFID (Radio Frequency Identification) systems, where information are exchanged between a transceiver of the warehouse or other locations, and the transceiver 170 of the mobile device 100. Any means of communication may be used, wired or wireless.

Of course, the information exchanged between the mobile transceiver 170 and another transceiver (such as a master transceiver or transceiver of the warehouse or a global system management) may include further information in addition to the location information. Such further information may include the time and date, as well as specific mobile device configuration information and/or commands to reconfigure the mobile device 100, which may be based on time and date as well as the particular usage and/or user of the mobile device.

The particular user of the mobile device 100 may be identified by any means, such as via RFID technology, or visually via cameras that may include face recognition software, for example. Based on the time, date, location and duties or clearance level of the identified user, the processor 120 may be configured to control the mobile device 100, such as reconfigure the fixed and/or displayed UIs, perform power management (e.g., switch among different power modes, such as switch ON/OFF/Standby different elements of the mobile device 100), and/or provide or deny access to certain functions of the mobile device 100, and the like.

The location detector 144 may also be configured to receive manual user input (e.g., through the fixed UI 150 and/or the displayed UI displayed on the display 160) relating to or indicating the current location of the mobile device, and/or desired mode of operation, as well as other information, such as time and dates. Of course, various predetermined or programmable locations may be displayed on the display 160 for user selections. For example, a list of locations or other information may be included in a drop down menu for display in response to user input. Similar lists or menus may be provided for user selection of other features, such as time, date, system configuration, power management modes, etc. For example, default, predetermined and/or generated (e.g., by the processor 120 based on usage, time, date, location and the like) power management modes and various system configurations may displayed in response to user input, such as pointing to an icon or menu bar displayed on the display 160, for selection of the listed information or input thereof by the user.

A further sensor element may be a usage detector 146 configured to detect user inputs and/or use of various functions, elements, and/or buttons the mobile device 100. Based on detected usage and other detected information, such as time, date, location, the processor 120 may be configured to generate a usage profile associated with the detected time, date, location, and/or user, for example.

Illustratively, in operation, the sensor 140 may be configured to monitor several parameters such as location, time, date, and/or usage data. Based on these or other parameters, which may be autonomously or automatically detected and/or provided to the processor 120, e.g., via user input or from a global system manager (of a warehouse for example), the processor 120 may implicitly generate a usage profile that is used to dynamically configure the mobile device 100, such as to reconfigure the function of keys, buttons, UIs and/or power modes.

Of course, the user and/or device profile may be provided or generated explicitly based on user responses to questions presented to the user, instead of implicitly from previous usage history, for example, associated with time of day, day of week, location, user's job function or clearance, etc.

For example, after several uses, the mobile device 100 may detect that it is used frequently between 9 AM and 5 PM. As a result, the mobile device 100 may never completely shut-off during these hours, but only revert to a power-off or standby mode during periods of non-use. Thus, activating or pressing the power button (or any other button) on the mobile device 100, switches the mobile device 100 to a low-power or standby mode, instead of a complete shut-down or hard-OFF mode. Illustratively, in the low-power or standby mode, the display 160 and/or other non-critical functions or elements are switched to a standby mode; however, the mobile device 100 is not completely off.

Going to a low-power mode has various benefits, such as allowing the user to resume operation quickly. For example, had the user completely powered-off the mobile device 100, it would take a long time to restart the mobile device 100, similar to booting up a desktop or laptop computer, for example.

Similarly, between 5 PM and 9 AM, the mobile device 100 or sensor 140 may detect that the mobile device 100 is infrequently used, and the processor 120 may be configured to completely power off the mobile device 100, either after detection of a period of non-use or inactivity, and/or in response to the user activating the power ON/OFF button, for example. Pressing the power button during these hours would cause the mobile device 100 to completely shut off if On or, if OFF then to “reboot”, which takes longer to resume or reach an ON state than resuming operation when switched ON from the low-power or standby mode. The mobile device 100 may implement a similar system for weekends and holidays.

The processor 120 may also use location information to configure the mobile device 100. For example, in response to information from the sensor 140 indicating detection that the mobile device 100 is in a warehouse (or any other predefined boundary, for example), the processor 120 may switch the mobile device 100 into a full power mode, powering all, or substantially all, functional units of the mobile device 100, such as a scan engine, transceiver, display screen, volume, etc.

The processor 120 may also reconfigure the user interface(s) of the mobile device 100, e.g., the fixed UI 150 and/or displayed UI, based on the parameters detected by the sensor 140 and/or supplied thereto, such as, via user input. For example, during different times, dates, locations, users and/or profiles, buttons on a keypad of the UI may be reconfigured to provide different buttons, different layout, and/or perform different functions. For example, the UT button(s) may be reconfigured for providing scanning functions if the detected user is a warehouse clerk, located in the warehouse, during work hours (e.g., 9 AM to 5 PM).

During the weekend or night hours, the UT buttons may be reconfigured for selection of leisure information, such as music or video files, or other functions such a telephone functions, or playing video games displayed on the display 160 for example. When the detected location is the home, the processor 120 may reconfigure the user interfaces and/or button(s) of the mobile device 100 as a remote control to control various devices in the home, such as the television, audio/visual systems or other systems, such as temperature and lighting control, for example. Other functional units of the mobile device 100 that are not suitable for the detected time, date, or location may be turned OFF, such as turning OFF a scanning function when at home. Such a power management, where unnecessary functions and elements of the mobile device 100 are turned OFF, extends battery life and operation time before the battery needs to be charged.

Power management further alleviates the need for bigger batteries to power all the features or functions of the mobile unit. This allows mobile unit to last longer on a single charge. The smaller batteries allow for further miniaturization of the mobile unit.

Of course, it is to be appreciated that any one of the above embodiments or processes may be combined with one or with one or more other embodiments or processes to provide even further improvements in power management and system/UI reconfiguration, for example.

These and other variations should be understood to be within the scope of the presented claims. As should be clear from the discussion herein, the present system overcomes various disadvantages and/or makes improvements over other systems.

Finally, the above-discussion is intended to be merely illustrative of the present system and should not be construed as limiting the appended claims to any particular embodiment or group of embodiments. Thus, while the present system has been described in particular detail with reference to specific exemplary embodiments thereof, it should also be appreciated that numerous modifications and alternative embodiments may be devised by those having ordinary skill in the art without departing from the broader and intended spirit and scope of the present system as set forth in the claims that follow.

In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the-word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same or different items or structures or functions;

e) any of the disclosed devices or portions thereof may be combined together or separated into further portions unless specifically stated otherwise; and

f) no specific sequence of acts or steps is intended to be required unless specifically indicated.

The claimed invention is:

1. A mobile device comprising:
a sensor configured to detect a usage profile of the mobile device; and
a processor configured to reconfigure the mobile device in response to the usage profile.

2. The mobile device of claim 1, wherein the usage profile is based on at least one of time, dates, location and user of the mobile device.

3. The mobile device of claim 1, wherein the processor is further configured to switch a power mode of the mobile device in response to the usage profile.

4. The mobile device of claim 1, wherein the processor is further configured to reconfigure a user interface of the mobile device in response to the usage profile.

5. The mobile device of claim 1, wherein the processor is further configured to reconfigure a function of a button of the mobile device in response to the usage profile.

6. The mobile device of claim 1, wherein the processor is configured to reconfigure the mobile device in response to a user profile of a user of the mobile device.

7. The mobile device of claim 1, wherein the sensor includes at least one of a timer, a location detector, a usage detector and a user detector.

8. A system comprising:
detection means for detecting a usage profile of a mobile device; and
configuration means for reconfiguring the mobile device in response to the usage profile.

9. The system of claim 8, wherein the usage profile is based on at least one of time, dates, location and user of the mobile device.

10. The system of claim 8, wherein the configuration means switches a power mode of the mobile device in response to the usage profile.

11. The system of claim 8, wherein the configuration means reconfigures a user interface of the mobile device in response to the usage profile.

12. The system of claim 8, wherein the configuration means reconfigures a function of a button of the mobile device in response to the usage profile.

13. The system of claim 8, wherein the configuration means reconfigures the mobile device in response to a user profile of a user of the mobile device.

14. The system of claim 8, wherein the detection means includes at least one of a timer, a location detector, a usage detector and a user detector.

15. A method of operating a mobile device, comprising the acts of:
detecting a usage profile of the mobile device; and
reconfiguring the mobile device in response to the usage profile.

16. The method of claim 15, wherein the usage profile is based on at least one of time, dates, location and user of the mobile device.

17. The method of claim 15, wherein the reconfiguring act switches a power mode of the mobile device in response to the usage profile.

18. The method of claim 15, wherein the reconfiguring act reconfigures at least one of a user interface and a function of a button of the mobile device in response to the usage profile.

19. The method of claim 15, wherein the reconfiguring act reconfigures the mobile device in response to a user profile of a user of the mobile device.

20. The method of claim 15, wherein the detecting act includes detecting at least one of time, location, usage and a user of the mobile device.
